(19) United States
(12) Patent Application Publication
(10) Pub. No.: US 2017/0078967 A1
(43) Pub. Date: Mar. 16, 2017

(54) EFFICIENCY AND COEXISTENCE OF WIRELESS DEVICES

(71) Applicant: QUALCOMM Incorporated, San Diego, CA (US)

(72) Inventors: Alfred ASTERJADHI, San Diego, CA (US); Sandip HOM CHAUDHURI, San Jose, CA (US); Zhanfeng JIA, Belmont, CA (US); George CHERIAN, San Diego, CA (US); Simone MERLIN, San Diego, CA (US); Alireza RAISSINIA, Monte Sereno, CA (US); Gwendolyn Denise BARRIAC, Encinitas, CA (US); James Simon CHO, Mountain View, CA (US); Yan ZHOU, San Diego, CA (US); Deepak Jindal KUMAR, Hyderabad (IN)

(21) Appl. No.: 15/259,909

(22) Filed: Sep. 8, 2016

Related U.S. Application Data
(60) Provisional application No. 62/297,576, filed on Feb. 19, 2016.
(60) Provisional application No. 62/244,122, filed on Oct. 20, 2015.
(60) Provisional application No. 62/216,963, filed on Sep. 10, 2015.

(51) Int. Cl. H04W 52/02; H04W 8/00; H04L 12/26; H04W 74/06

(52) U.S. Cl. CPC H04W 52/0229; H04W 74/06; H04W 8/005; H04L 43/103; H04W 84/12

(57) ABSTRACT

Certain aspects of the present disclosure provide methods and apparatus for polling for data by a wireless device. Certain aspects of the present disclosure providing a method performed by the wireless device. The method generally includes receiving a polling frame from at least one wireless device. The polling frame can include an indication of a service period during which the access point may deliver multiple protocol data units (PDUs) to the wireless device in response to the polling frame. The indication of the service period is provided as a value relative to a local clock synchronized between the wireless device and the access point. The method generally also includes transmitting the multiple PDUs to the wireless device during the service period, in response to the polling frame. The access point can receive the polling frame and transmit the multiple PDUs during the service period, in response to the polling frame.

### CROSS-REFERENCE TO RELATED APPLICATION & PRIORITY CLAIM

This application claims benefit of and priority to U.S. Provisional Patent Application Ser. No. 62/216,963, filed Sep. 10, 2015, U.S. Provisional Patent Application Ser. No. 62/244,122, filed Oct. 20, 2015, and U.S. Provisional Patent Application Ser. No. 62/297,576, filed Feb. 19, 2016, which are herein incorporated by reference in their entirety for all applicable purposes.

### FIELD OF THE DISCLOSURE

Certain aspects of the present disclosure generally relate to wireless communications and, more particularly, to techniques that may help improve efficiency and coexistence of devices that enter power savings modes.

### DESCRIPTION OF RELATED ART

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various schemes are being developed. One such scheme is the sub-1-GHz (S1G) frequency range (e.g., operating in the 902-928 MHz range in the United States) being developed by the Institute of Electrical and Electronics Engineers (IEEE) 802.11ah task force. Another such scheme is the 2.4 and/or 5 GHz frequency range and using Multiple-Input Multiple-Output (MIMO) OFDM modulation being developed by the IEEE 802.11 ax task force. This development is driven by the desire to utilize a frequency range that has greater wireless range than other IEEE 802.11 groups and has lower obstruction losses.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Aspects of the present disclosure provide techniques that may help improve efficiency and coexistence of devices that enter power savings modes.

Certain aspects of the present disclosure provide an apparatus for wireless communications by a wireless device. The apparatus generally includes a memory and at least one processor coupled with the memory and configured to generate a polling frame to poll an access point for data, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and transmit the polling frame to the access point.

Certain aspects of the present disclosure provide a method for wireless communications by an access point. The method generally includes receiving a polling frame from at least one wireless device, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and transmitting the multiple PDUs to the wireless device during the service period, in response to the polling frame.

Certain aspects of the present disclosure provide a method for wireless communications by a wireless device. The method generally includes generating a polling frame to poll an access point for data, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and transmitting the polling frame to the access point.

Certain aspects of the present disclosure provide a method for wireless communications by an access point. The method generally includes receiving a polling frame from at least one wireless device, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and transmitting the multiple PDUs to the wireless device during the service period, in response to the polling frame.

Certain aspects of the present disclosure provide an apparatus for wireless communications by a wireless device. The apparatus generally includes means for generating a polling frame to poll an access point for data, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and means for transmitting the polling frame to the access point.

Certain aspects of the present disclosure provide an apparatus for wireless communications by an access point. The apparatus generally includes means for receiving a polling frame from at least one wireless device, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and means for transmitting the multiple PDUs to the wireless device during the service period, in response to the polling frame.

Certain aspects of the present disclosure provide a computer readable medium having computer executable code stored thereon for wireless communications by a wireless device. The computer executable code generally includes code for generating a polling frame to poll an access point for data, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and code for transmitting the polling frame to the access point.

Certain aspects of the present disclosure provide a computer readable medium having computer executable code stored thereon for wireless communications by an access point. The computer executable code generally includes code for receiving a polling frame from at least one wireless device, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and code for transmitting the multiple PDUs to the wireless device during the service period, in response to the polling frame.

Certain aspects also provide various methods, apparatuses, and computer program products capable of performing operations corresponding to those described above. Other aspects, features, and embodiments of the present disclosure will become apparent to those of ordinary skill in the art, upon reviewing the following description of specific, exemplary aspects of the present disclosure in conjunction with the accompanying figures. While features of the present disclosure may be discussed relative to certain aspects and figures below, all aspects of the present disclosure can include one or more of the advantageous features discussed herein. In other words, while one or more aspects may be discussed as having certain advantageous features, one or more of such features may also be used in accordance with the various aspects of the disclosure discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates an example exchange of messages using a conventional polling technique.

FIG. 5 illustrates a block diagram of example operations for wireless communications by a wireless device, such as a station (STA), in accordance with certain aspects of the present disclosure.

FIG. 6 is a block diagram illustrating example operations for wireless communications by an access point, in accordance with certain aspects of the present disclosure.

FIG. 7 illustrates an example polling frame format, in accordance with certain aspects of the present disclosure.

FIG. 7A illustrates an example duration field of the polling frame format illustrated in FIG. 7, in accordance with certain aspects of the present disclosure.

FIG. 8 illustrates an example exchange of messages using a single user (SU) polling technique, in accordance with certain aspects of the present disclosure.

FIG. 8A illustrates an example exchange of messages using a multi-user (MU) polling technique, in accordance with certain aspects of the present disclosure.

FIG. 9 illustrates an example management frame format, in accordance with certain aspects of the present disclosure.

FIG. 10 illustrates another example format of a polling frame, in accordance with certain aspects of the present disclosure.

FIG. 11 illustrates an example exchange of messages using a polling technique.

FIGS. 12 and 13 illustrate example exchanges of messages using a conventional null frame based technique.

FIGS. 14 and 15 illustrate example exchanges of messages using a clear-to-send-to-self based technique.

FIGS. 16 and 17 illustrate example exchanges of messages using a new null frame based technique, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure relate to techniques for devices in a power saving mode to poll an access point for data. As described herein, conventionally, devices in a power saving mode can send a polling frame to an access point for a single data packet. Thus, the device may send multiple polling frames in order to get more data packets.

Aspects described herein provide methods and apparatus to provide an indication in a polling frame of a duration (e.g., an ending time) for a service period in which the device can receive multiple packets from the access point in response to the single polling frame.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

It is noted that while aspects may be described herein using terminology commonly associated with 3G and/or 4G wireless technologies, aspects of the present disclosure can be applied in other generation-based communication systems, such as 5G and later.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

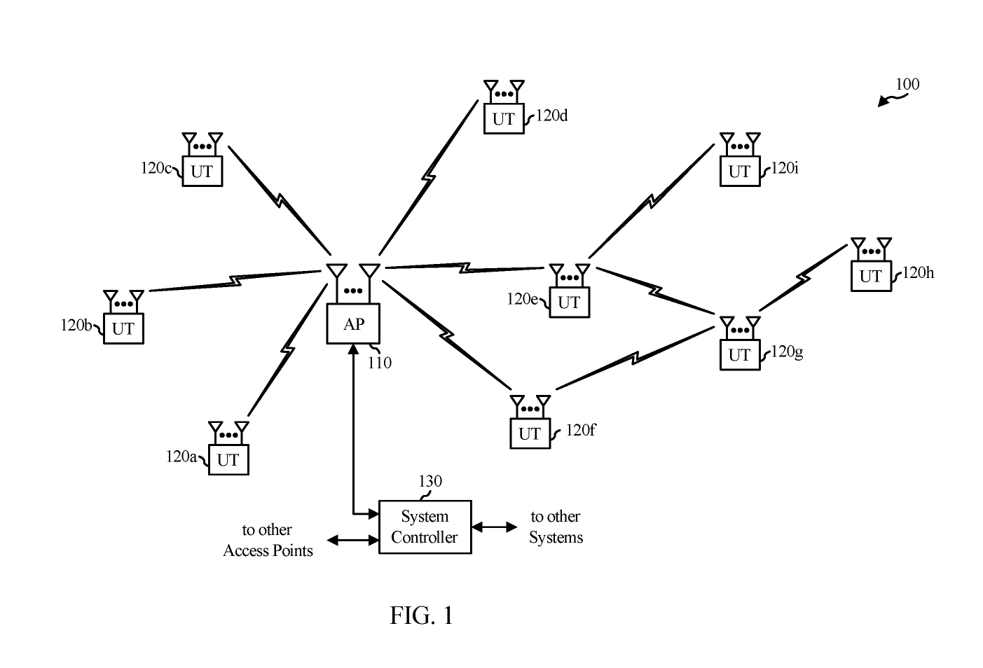

FIG. 1 illustrates an example wireless communications system in which aspects of the present disclosure may be performed. For example, a user terminal 120 (e.g., in a deep sleep mode) can generate a polling frame to poll an access point 110 for data. The polling frame includes an indication of a service period during which the access point 110 may deliver multiple protocol data units (PDUs) to the user terminal 120 in response to the polling frame. The indication of the service period can be provided as a value relative to a local clock synchronized between the user terminal 120 and the access point 110. The user terminal 120 can transmit the polling frame to the access point 110. The access point 110 can receive the polling frame and send multiple MPDUs to the user terminal 120 during the service period, in response to the polling frame.

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

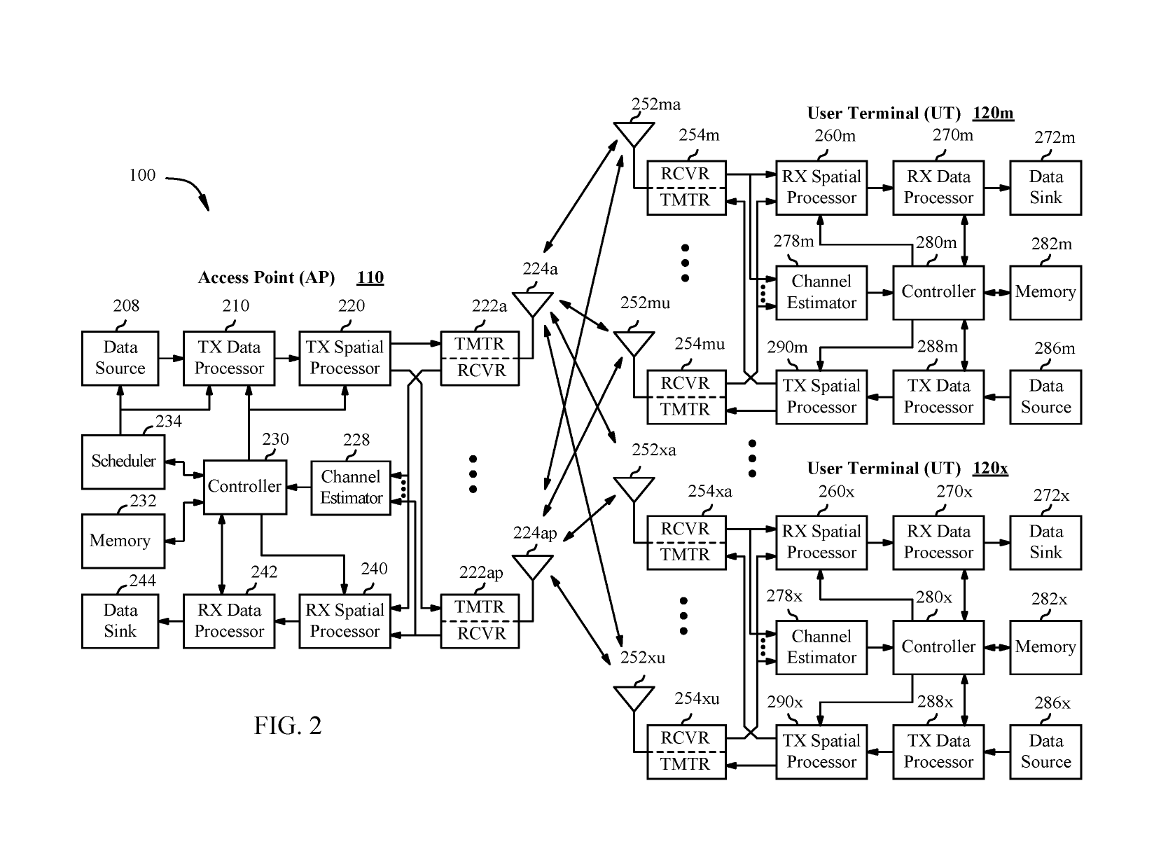

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, and/or processors 210, 220, 240, 242, of the AP 110, and/or controller 230 or antenna 252, Tx/Rx 254, processors 260, 270, 288, and 290, and/or controller 280 of UT 120 may be used to perform the operations described herein.

FIG. 2 illustrates a block diagram of access point 110 and two user terminals 120m and 120x in a MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

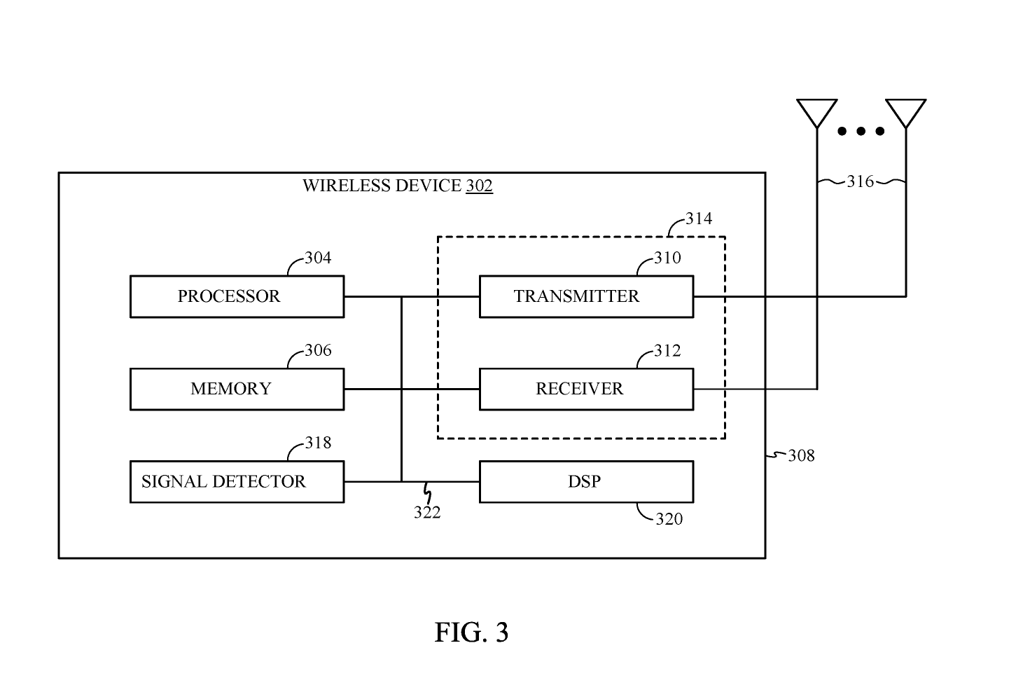

FIG. 3 illustrates various components that may be utilized in a wireless device 302 that may be employed within the MIMO system 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

In general, an AP and STA may perform similar (e.g., symmetric or complementary) operations. Therefore, for many of the techniques described herein, an AP or STA may perform similar operations. To that end, the following description will sometimes refer to an “AP/STA” to reflect that an operation may be performed by either. Although, it should be understood that even if only “AP” or “STA” is used, it does not mean a corresponding operation or mechanism is limited to that type of device.

### Example Efficient Power Save Poll

Techniques presented herein may be considered part of a power savings protocol that may allow STAs to conserve power and efficiently receive data from an access point. However, one knowledgeable in the art may appreciate that these techniques may be used to enable efficient coexistence mechanisms between the station and other devices (whether they use the same radio access technology or different radio access technologies).

As will be described in greater detail below, a station (e.g., a non-AP STA) may be configured to enter a low power state (e.g., a sleep mode with radio components powered down) in order to conserve battery power. In some cases, the STA may be configured with scheduled wakeup periods, during which the STA may transmit and receive data.

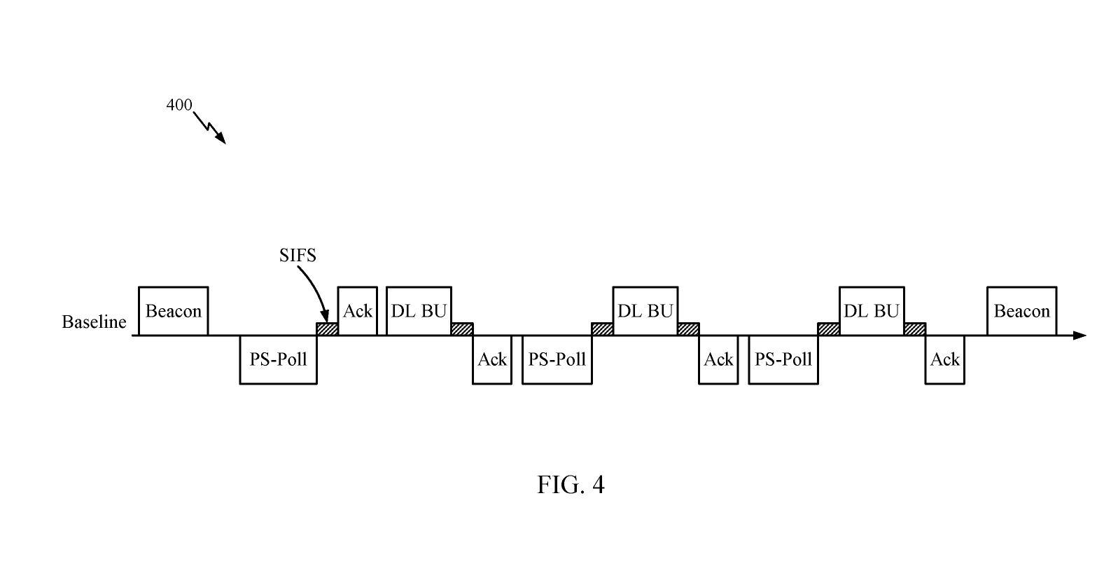

In general, non-AP STAs that are associated with an AP can be either in an active mode (AM) or a power save (PS) mode. As illustrated in FIG. 4, a STA (e.g., such as a UT 120) that is in PS mode may send a polling message, referred to as a PS-Poll frame, to poll the AP (e.g., such as AP 110) for delivering any available downlink (DL) bufferable units (BUs). The AP may respond with an acknowledgement (ACK) followed by a DL BU or may respond directly with the DL BU. Upon reception of the DL BU, the STA may respond with an ACK frame if the reception is successful. If the DL BU is not received successfully the STA may either not respond with an ACK frame or may respond with a NACK frame.

According to current systems, as illustrated in FIG. 4, the AP may deliver only a single DL BU, such as a single medium access control (MAC) protocol data unit (MPDU) for each received PS-Poll frame. As a result, the STA needs to send multiple PS-Polls to the AP to poll for multiple MPDUs as shown in FIG. 4.

The PS Polling operation shown in FIG. 4 may be less than optimal for high efficiency (HE) STAs because multiple frames (e.g., contention and/or control frames) are used to poll multiple MPDUs. Further, there is little use of multi-user operation for data delivery, as each single station polls for a single data unit. Further, there is currently no mechanism to provide dynamic coexistence with other devices, meaning each device must perform conventional contention when accessing the medium to poll for data. Coexistence is especially important in certain cases where, due to interference (e.g., experienced, expected, or planned interference) or unavailability of resources, the STA may need to indicate to the AP specific times during which it is available to receive or transmit frames (whether these exchanges are in single user mode, or in multi user mode).

Aspects of the present disclosure provide an enhanced PS polling mechanism that may allow for multiple MPDUs to be delivered in response to a PS-Poll frame (that may be referred to as an HE PS-Poll frame) or to a frame that achieves polling functionalities.

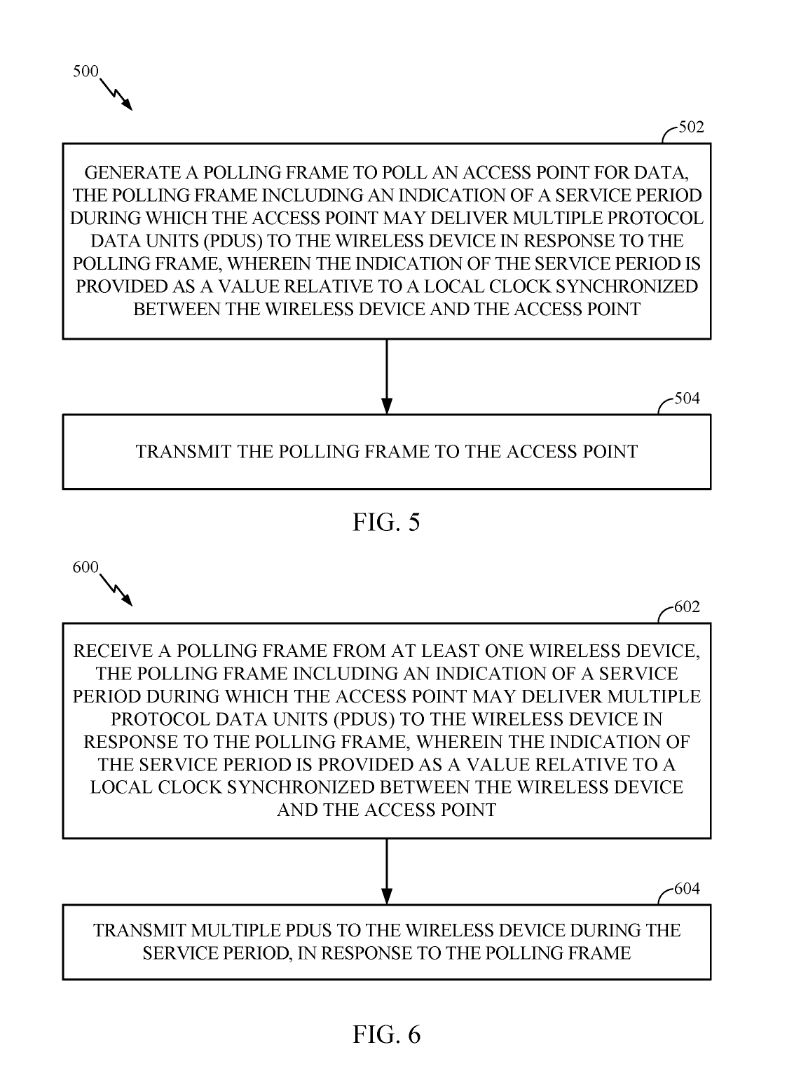

FIG. 5 illustrates example operations 500 for polling that may be performed, for example, by a wireless device such as a non-AP STA (e.g., UT 120), in accordance with aspects of the present disclosure.

Operations 500 begin at 502, by generating a polling frame (e.g., an HE PS-Poll frame) to poll an access point for data, the polling frame including an indication of a service period (e.g., a WLAN interval) during which the access point may deliver multiple protocol data units (PDUs) to the wireless device in response to the polling frame (and optionally can also indicate a starting time of a subsequent service period), wherein the indication of the service period is provided as a value relative to a local clock synchronized between the wireless device and the access point. As will be described in more detail below, the polling frame may be management frame (e.g., in a control field) or a null frame (e.g., using reserved bits). The polling frame can also carry an indication of one or more receive parameters (e.g., number of spatial streams, number of channel bandwidth, and/or a modulation and coding scheme (MCS)) to be used in at least one of the service period or a subsequent service period and can also indicate the one or more receive parameters are changed relative to a default or current set of receive parameters.

At 504, the wireless device transmits (e.g., as an SU- or MU-transmission) the polling frame to the access point. The indication of a service period may be in terms of the duration of the service period, or as an indication of the end time of the service period. The polling frame may be a single polling frame and the wireless device can receive the multiple PDUs during the service period in response to the single polling frame. The wireless device can transmit a block acknowledgement frame acknowledging the multiple PDUs received from the access point during the service period. The wireless device may indicate, during an association procedure with the access point, a capability of the wireless device to send the null frame carrying the indication. The wireless device may also set a value of a field in the null frame to indicate that the wireless device is entering a power save mode.

FIG. 6 illustrates example operations 600 that may be performed, for example, by an access point (e.g., AP 110), to respond to a wireless device polling in accordance with operations 500 of FIG. 5.

Operations 600 begin at 602, by receiving a polling frame from at least one wireless device, the polling frame including an indication of a service period during which the access point may deliver multiple protocol data units (PDUs) to the wireless device in response to the polling frame, wherein the indication of the service period is provided as a value relative to a local clock synchronized between the wireless device and the access point. At 604, the access point transmits the multiple PDUs to the wireless device during the service period, in response to the polling frame.

### Example Service Period Indication in PS-Poll Frame

By indicating duration of a service period, the HE PS-Poll frame may also provide an improved coexistence mechanism. In general, the service period may define a duration for which the AP is able to send multiple MPDUs in response to a PS-Poll. As will be described in greater detail below, there are various possible mechanisms for signaling the service period and, in some cases, PS-Polls (or UL frames in general) and corresponding delivery of MPDUs may be sent as MU transmissions, increasing efficiency even further.

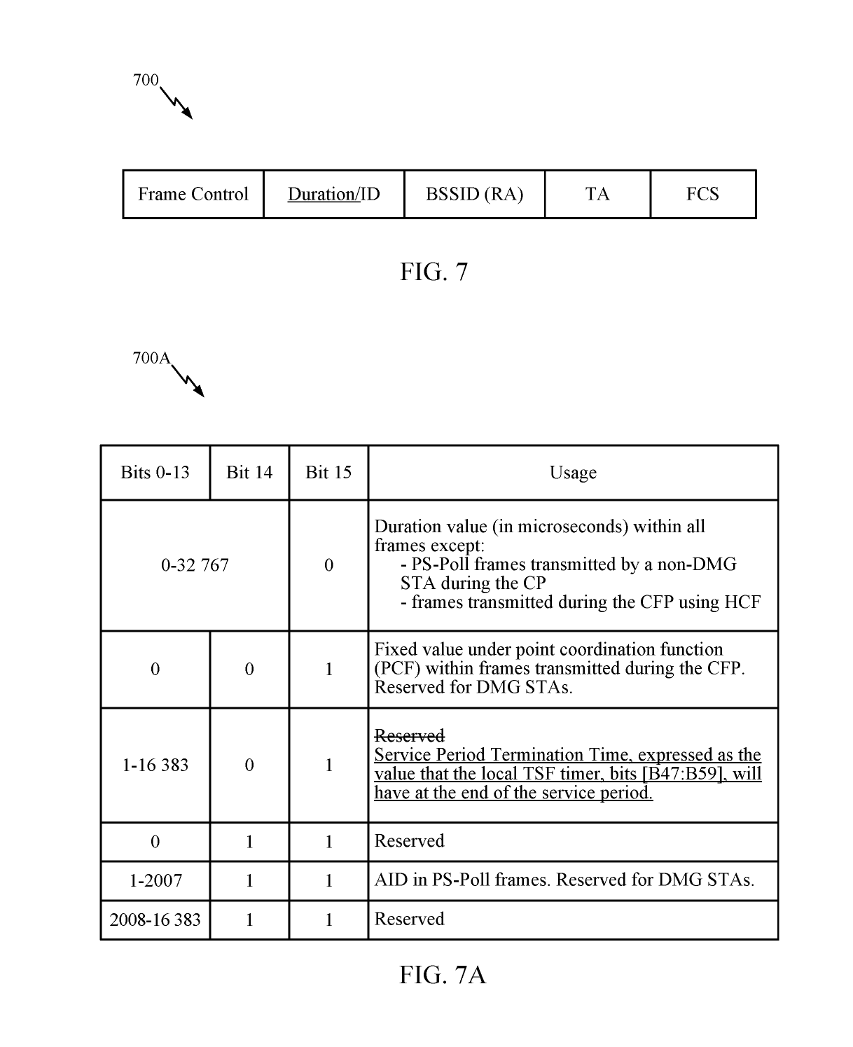

FIG. 7 illustrates an example structure of an HE PS Poll frame 700. In this example, the duration of a Service Period may be provided via a Duration/ID field of the HE PS Poll Frame 700. As illustrated in FIG. 7A, the service period may be signaled using (previously) reserved bits of the Duration/ID field and may be provided as a Service Period Termination Time (SPTT), expressed as the value that the local time synchronization function (TSF) timer or parts of it (e.g., using bits 47-59 of an 8 Byte TSF timer), will have at the end of the service period. Signaling the end of the service period in this manner may facilitate detection of the end of the service period via a simple comparison with (corresponding bits of) the local TSF timer of the receiving STA. In the example, an SPTT containing bits B47 to B59 of the local TSF timer is specified to reflect a design wherein the SPTT is carried in a 12 bit field and has a resolution of 16 microseconds (e.g., assuming the TSF timer is carried in an 8 byte Timestamp field and specifies a value of a resolution of 1 microsecond). In certain aspects, the SPTT may be carried in a longer field or with a different resolution, in which cases the contents of the SPTT may be arranged accordingly.

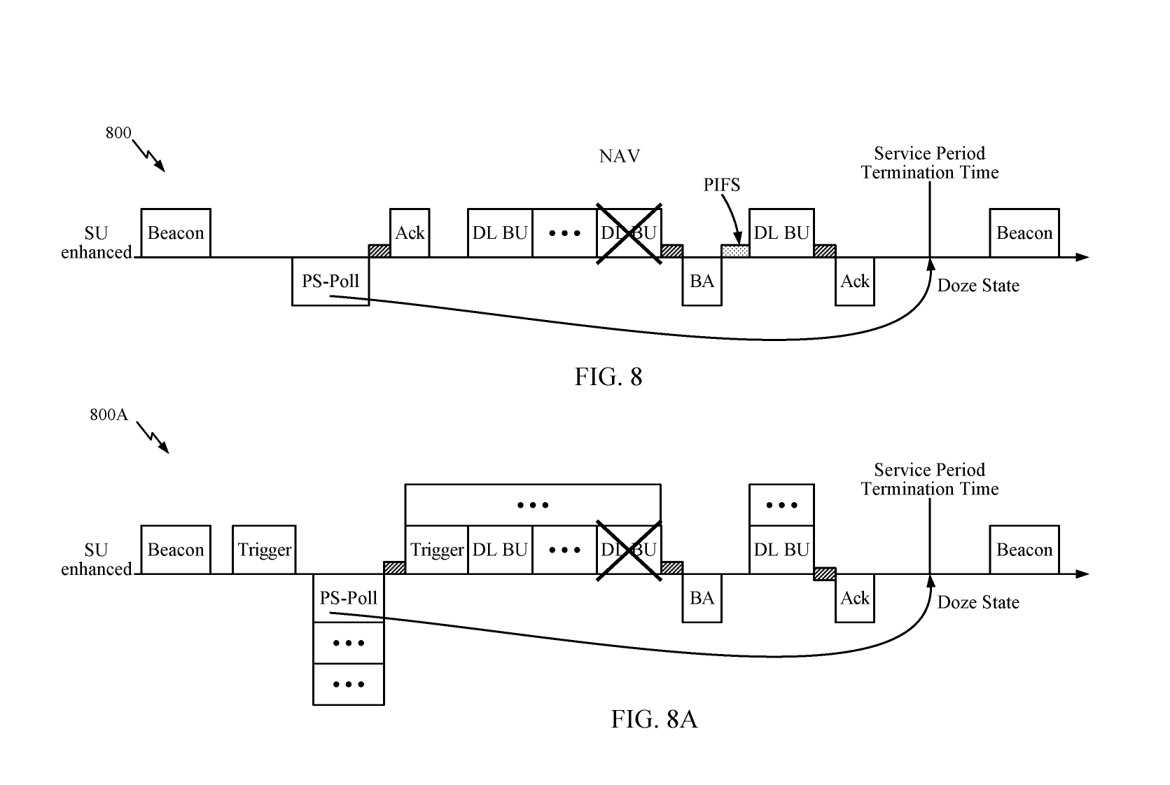

As illustrated in FIGS. 8 and 8A, the HE PS-Poll and corresponding DL BU delivery may be performed as single user (SU) (FIG. 8) or MU (FIG. 8A) transmissions. As illustrated, the AP receiving an HE PS-Poll frame from an HE STA generally has up to the service period (SP) duration to deliver DL BUs (plus expected responses) to the STA or to enable UL delivery of frames from the STA (in SU mode or MU mode). In some cases, at the end of the SP duration, the AP may assume the STA is in a low power (e.g., Doze) state. As such, the AP may not transmit frames or expect the STA to transmit frames to the AP after the end of the SP.

The immediate response to the PS-Poll frame, from the AP, may be an ACK frame, followed by a DL A-MPDU of a given TID (choice of TID at AP's discretion, however generally of a TID for which the AP has indicated presence of DL BUs in the TIM element carried in the Beacon frame preceding the reception of the PS-Poll frame). As illustrated, further DL traffic can be delivered and/or triggered by the AP to/by the STA during the SP. In general, the AP and the STA may exchange any type of traffic (depending on availability and/or capability) as long as the duration of the exchange does not exceed the specified SPTT by the STA. While examples described herein refer to a STA activating such procedure, an AP may also activate the same procedure.

In general, by providing a service period during which multiple MPDUs can be delivered in response to a single polling message, the techniques provided herein may improve efficiency and increase throughput.

As described above, a power-save (PS) STA may have different PS mechanisms. In what may be considered a baseline PS mode, the STA may send a PS-Poll frame to solicit a single MPDU from the AP. This mode may be inefficient as it may require the STA to send multiple PS-Poll frames to receive multiple MPDUs. In what may be considered an enhanced mode (of unscheduled automatic power-save delivery “U-APSD”), the STA may send a single (trigger or polling) frame to solicit a plurality of buffer units from the AP. In some cases, such a frame may be sent per access category (AC) to solicit BUs from the AP for each AC. While this mode may be more efficient than the baseline PS mode, it may still require multiple trigger frames for multiple ACs.

In addition, it may be desirable to provide an effective coexistence mechanism (with different devices coexisiting on a same shared medium). While the APSD mode described above provides some degree of coexistence (allowing other devices to know when devices are accessing the medium or when they are in a low power state and not accessing the medium), it is mostly for static and/or periodic coexistence signaling. One example of available signaling for coexistence is the APSD coexistence element, which may indicate a Coexistence Service Period (SP). However, this signaling may only be provided via management frames and may not very efficient for dynamic signaling of variable time periods for coexistence.

In some cases, a station may indicate a change in a receiver operating mode, for example, via a receive operating mode indication (ROMI) provided in a field of a MAC header (e.g., of a management or data frame). This ROMI may indicate changes in receive resources (space, frequency) during a scheduling period (SP), which may help increase efficiency and improve coexistence with minimal MAC overhead exchanges. In some cases, it may also be desirable, for coexistence, to signal time (another dimension). In some cases, time (in the form of a service period termination time or SPTT) may be signaled in Data frames and, as described above with reference to FIGS. 8 and 8A, may also be signaled in PS-Poll frame).

Aspects of the present disclosure, allow enhancements to the SPTT signaling described above, which may help enable coexistence in time—not only in space and frequency, and may improve efficiency and achievable throughput. In some cases, in addition to (or as an alternative to) indicating a SPTT via a PS-POLL, a non-AP STA may indicate an SPTT (e.g., as a TSF value of the target time) in a management frame used to poll for multiple BUs within a service period. Providing an SPTT (via a polling message such as a PS-POLL or management frame, or data frame) may allow dynamic signaling per SP without the need of additional frame exchanges.

As described above, an AP receiving an SPTT from an associated STA may deliver DL BUs to the STA. In some cases, an AP receiving an SPTT may also activate UL delivery procedures (e.g., UL MU), for example, as long as the UL exchanges do not exceed the SPTT specified by the STA. In some cases, during the SP, a station may also specify various receive parameters, such as a number of receive streams (Rx NSS) and Rx Channel Width used by the AP to deliver the frames to the STA. In some cases, the receive parameters may also include MCS (e.g., MCS to be used during the current SP or a subsequent SP).

The SPTT information may be provided in various manners. For example, one option is to use a value of a Control ID of a control field (e.g., an HE A-Control field) to indicate SPTT. As another option, a same value of a Control ID of HE A-Control field may be used to indicate both ROMI and SPTT information. In some cases, a control field (e.g., an HE A-Control field) may carry SPTT (e.g., 3 Bytes) and there may be separate signaling of Rx parameters (such as RX NSS and RX Channel Width). Such separate signaling may be used as it may not be possible to carry ROMI and SPTT information in a same (e.g., 4-byte) HE A-Control field.

However, since Rx NSS and Rx CW may be specific to the (current) SP, it may be desirable (but not necessary) that both ROMI and SPTT values are be carried within the same frame.

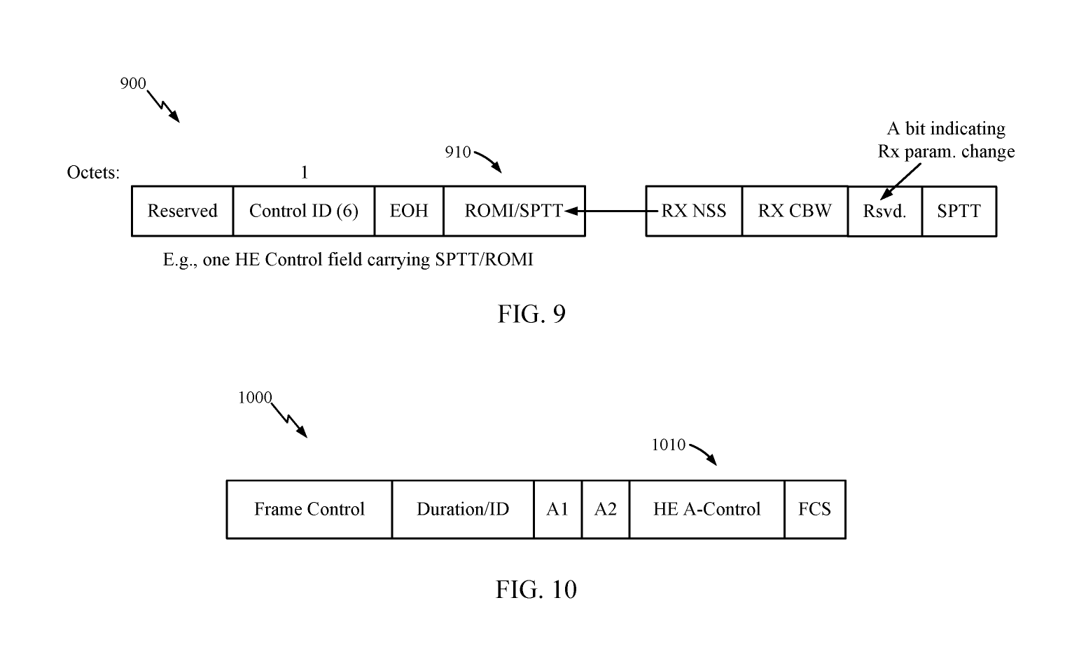

FIG. 9 illustrates an example of a control field format 900, in accordance with certain aspects of the present disclosure, in which both ROMI and SPTT information are provided in a portion (subfield) 910. As illustrated, both ROMI and SPTT (e.g., Rx NSS, Rx CW, and SPTT) may be carried in the same 4-byte HE A-Control field. The actual number of bits used for each parameter may vary (e.g., 3 bits each for RX NSS and RX CBW and 2 bytes for SPTT). This approach may be beneficial as these parameters are related to each other (space, frequency, time). In some cases, at the end of the SP, the AP may assume that the STA goes back to default mode (e.g., using parameters declared at association).

Dynamically specifying an SPTT may lead to efficiencies, for example, allowing the time to be adjusted based on buffered traffic (e.g., a device may be able to signal a lower time and return to a low power state sooner if there is less DL data to receive or UL data to transmit). Signaling this type of information may also allow adaptation to channel conditions (e.g., reduce interference, etc.) or improve range. For example, a STA may be able to signal a switch via a first channel (e.g., 2.4 GHz) to a second channel (e.g., 5 GHz) for a subsequent SP. This operation may allow the STA to benefit from better propagation (less path loss and better link budget) of a lower located frequency to send its frames and a higher located frequency (with greater BW) to receive frames from the AP (generally a STA transmits with lower power than an AP), so a 2.4 GHz channel may help closing the UL link while being able to receive the DL in 5 GHz. In some cases a number of bits may be used to indicate a different channel to switch to (e.g., with 2 bits, bit values of ‘00’ may indicate 900 MHz, ‘01’ may indicate 2.4 GHz, ‘10’ may indicate 5 GHz, and ‘11’ may indicate 20 GHz or greater). In addition, while not shown, a STA may be able to signal a Service period initiation time for each of the channels. The service period initiation time may indicate a start of a next SP (e.g., during which the receive parameters signaled are to be used). Additionally (though not shown and discussed in detail) a Service period initiation time (SPIT) may be conveyed using a similar signaling as described herein for SPTT.

As illustrated, in some cases, one or more bits may be used to indicate a change in the RX parameters (e.g., a change from default parameters or a change relative to parameters used by other STAs). This bit may indicate a change (from default/current parameters), so that the AP need not check the RX state of each STA. Carrying RX parameters (e.g., Nss, channel width, MCS etc.) and SPTT information as part of HE A-Control field, may allow such information to be carried in various types of frames, such as QoS Data and/or MGMT frames, as well as in an HE A-Control frame.

FIG. 10 illustrates an example format of such an HE-Control frame 1000 that may be sent as a polling frame (e.g., instead of a PS-Poll or trigger frame) by a capable PS STA. The HE-Control frame 100 may include a HE A-Control field 1010 that may have a format similar to that shown in FIG. 9. The HE A-Control field 1010 may specify the Rx parameters in ROMI/SPTT subfield described above, such as Rx Nss, Rx bandwidth, and SPTT. Other information may also be carried in the HE-Control frame 1000, such as CQI feedback, buffer status report, and the like. An HE AP receiving this HE A-Control frame 1000 from an HE PS STA may take up to SP termination time to deliver DL BUs to the transmitting STA. As noted above, after the specified SPTT, the AP may assume the STA to be in Doze state (e.g., in default operation mode).

According to certain aspects, a control frame (e.g., as an A-CTL frame) may be used to trigger exchanges with a specified SPTT, similar to the PS-Poll frame used in exchanges described above with reference to FIGS. 8 and 8A. In some cases, a response (e.g., an immediate response) to the HE-Control frame may be similar to a response to PS-Polls, but not limited to a single MPDU. For example, such a response may be an ACK frame and/or a DL (A-)MPDU as shown in FIGS. 8 and 8A. Such a downlink (A-)MPDU may contain a single traffic indicator (TID) or multiple TIDs (e.g., if multi-TID was negotiated with AP). As illustrated in FIGS. 8 and 8A, additional downlink and/or uplink traffic may also be exchanged between the AP and the STA during this SP. As illustrated in FIG. 8A, an SPTT may also be specified for the exchange of MU transmissions.

The techniques provided herein may enable multiple MPDU delivery within a dynamically signaled service period, which may improve efficiency and may provide a universal time-based coexistence mechanism for non-AP STAs. The techniques provided herein may enable a STA to specify a receive operation mode change in space (Rx NSS), frequency (Rx Channel Width) and in time (SPTT). Specifying SPTT may be useful, particularly, for time-based coexistence mechanisms. As such, the signaling described herein (whether SPTT and ROMI information is signaled together or separately) may provide improved efficiency and increased throughput for PS STAs and may enable reception of multiple PPDUs from AP compliant to RX requirements of PS STAs.

In addition, SPTT may be used by TWT STAs to indicate to their TWT peer STA(s) what is their expected termination time of the TWT Service Period (SP). Such information is typically negotiated and/or controlled by an AP, but SPTT signaling as described herein may enable dynamic signaling, either by TWT responder or by TWT requester.

In certain embodiments, the AP may limit the number of the STAs that can use coexistence mechanisms (e.g., that can dynamically specify receive parameters, and or SPTT values). In this case, the AP may indicate whether it allows a STA to associate if the STA intends to use a coexistence mechanism. For example, if the request exceeds the maximum number of STAs that the AP can manage to operate in this mode, the AP may not allow the STA to associate. This indication may be included as part of an element that is exchanged with the STA during association, reassociation, or during operation (e.g., by adding it in a beacon frame or any management frame that is exchanged with the STA (e.g., operation mode notification change frames). The AP may additionally specify whether it allows the STA to request an SPTT in any frame that it sends to the STA during a scheduling period. As an example, the AP may respond to a received frame sent by the STA that contains an SPTT (or other RX parameters) with a frame that contains an indication of whether the AP accepts or denies the STA to operate in the requested mode during the Service period.

### Example Null Frame Based Flow Control for Coexistence of Wireless Devices

According to certain aspects, null frames may be used for flow control and support for coexistence of wireless devices.

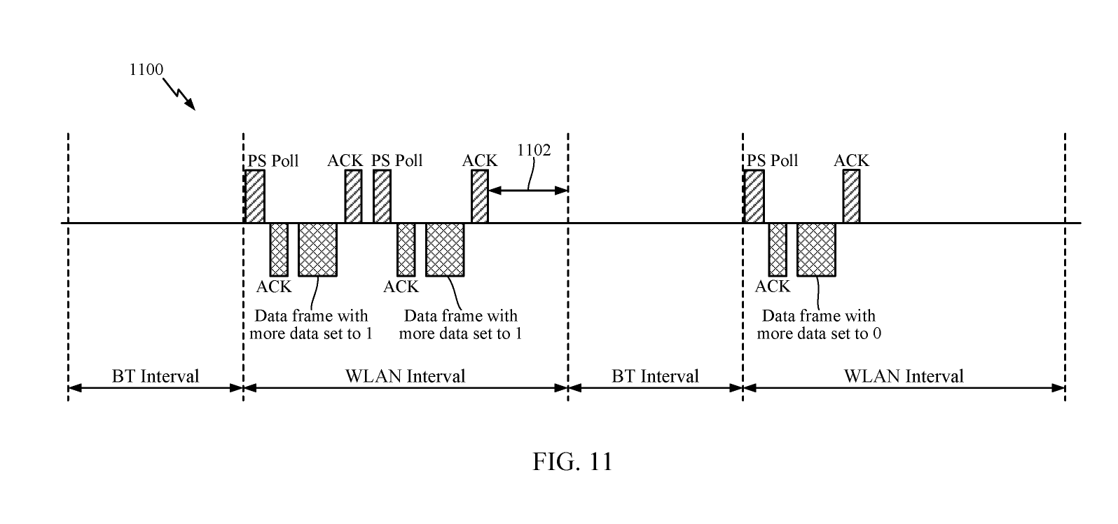

FIG. 11 illustrates an example exchange of messages using a conventional polling technique. As shown in FIG. 11, there may a BT interval followed by a wireless local area network (WLAN) interval. In the WLAN interval, the non-AP STA (e.g., UT 120) may send a PS-Poll to receive an MPDU from the AP (e.g., AP 110) or peer-to-peer device. As shown in FIG. 11, after receiving and acknowledging an MPDU, the time remaining in the WLAN interval (shown at 1102) may be insufficient to poll for and receive an additional MPDU, even if the last MPDU received indicated more data (e.g., more data set to 1).

The polling technique illustrated in FIG. 11 may have high overhead for sending PS-Polls, and ACK frames may also use significant backoff frames. Further, the approach shown in FIG. 11 may only allow one data frame to be sent in response to the PS-Poll frame, without any aggregation. Further still, the duration 1102 towards the end of the WLAN interval may be unutilized in the case that there is insufficient time for polling and receiving an additional MPDU.

In addition, the AP response time to the PS-Poll frame may be dependent on various network scenarios (e.g., the number devices communicating in the network, such as an internet-of-things (IoT) network, and parameters configured for the communications). For example, in a case where the PS-Poll/ACK and subsequent DL Data/ACK frames are not within the same transmission opportunity (TXOP), other traffic may be sent/received in between them, which may affect the response time to the PS-Poll frame. In addition, response time to a PS-Poll acknowledgment can vary for different peers in the network.

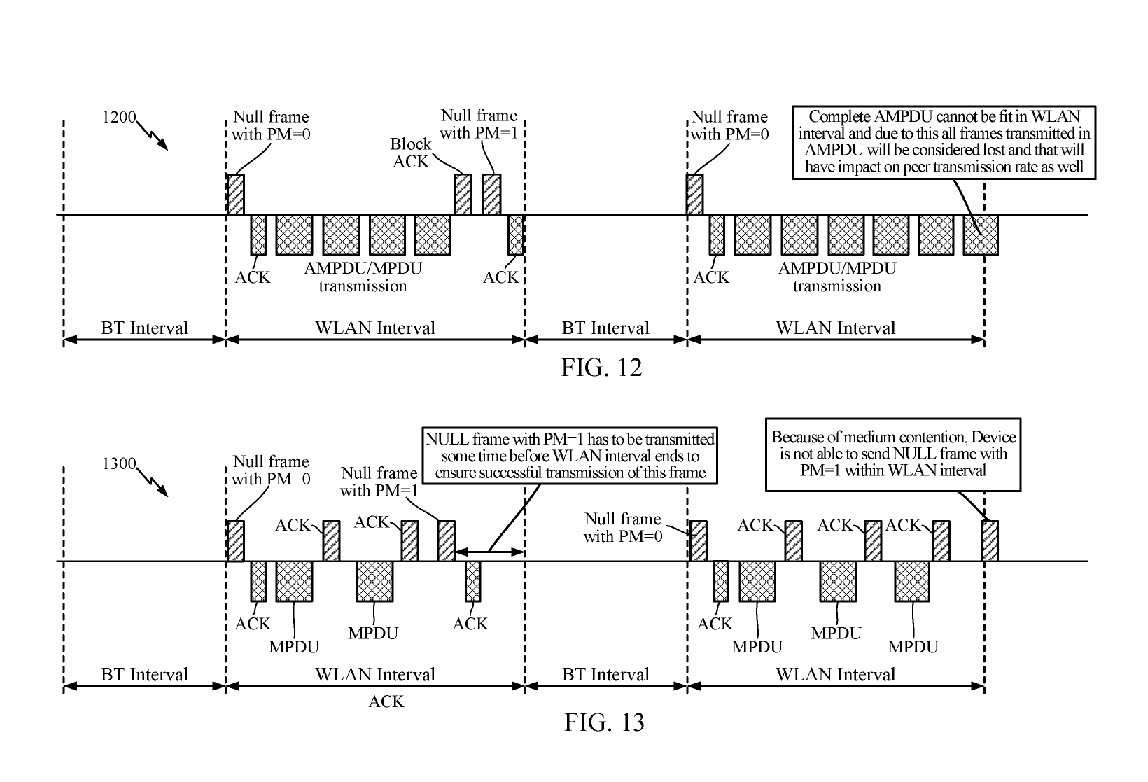

FIGS. 12 and 13 illustrate example exchanges of messages using a conventional null frame based technique. As shown in FIG. 12, during the WLAN interval, the non-AP STA can send a null frame (e.g., with PM set to 0) to the AP (or P2P device) to request MPDU(s) and/or A-MPDU(s). In response to the null frame, the AP can send an ACK frame to acknowledge the null frame and send multiple MPDU(s) and/or A-MPDU(s) to the requesting non-AP STA. The non-AP STA can receive the (A)MPDU(s) and respond with a Block Acknowledgment (BA) frame and a null frame with PM set to 1. However, as shown in FIG. 12, in some cases, after exchanging a null frame and ACK frame, an MPDU or A-MPDU may be sent by the AP but the complete (A-)MPDU may not fit in the WLAN interval and, therefore, the data frame may be lost.

As shown in FIG. 13, after sending the null frame, rather than receiving the multiple (A-)MPDUs and sending a BA frame, the non-AP STA may send an ACK frame after receiving each MPDU. As shown in FIG. 13, in some cases, after receiving an MPDU and sending an ACK frame, the null frame with PM set to 1 may not fit in the remaining WLAN interval (e.g., due to medium contention). If the non-AP STA is not able to transmit the null frame with PM=1 before the next BT interval starts, this may lead to unsuccessful transmission by the AP or P2P GO during the BT interval which, in turn, may result in the AP or P2P GO rate to drop.

The null frame approaches illustrated in FIGS. 12 and 13 may involve overhead, for example, for state transitions from PM=0 to PM=1. Overhead may include acknowledgments for the data frames (e.g., tens of milliseconds in poor radio frequency (RF) conditions). In some cases, the PM=1 transmission may be scheduled before the BT interval starts, for example, to avoid not being able send the PM=1 null frame during the WLAN interval. However, this may lead to some of the WLAN interval being unutilized.

Further, behavior of the AP/P2P GO can vary from peer to peer (e.g., peers in an IoT network). For example, the response time to PM mode entry (e.g., the time from sending an ACK for the null frame until the time of stopping data transmission) can vary. As another example, the response time to PM mode exit (e.g., the time from sending the ACK for the null frame until the time of starting transmission of data) can vary.

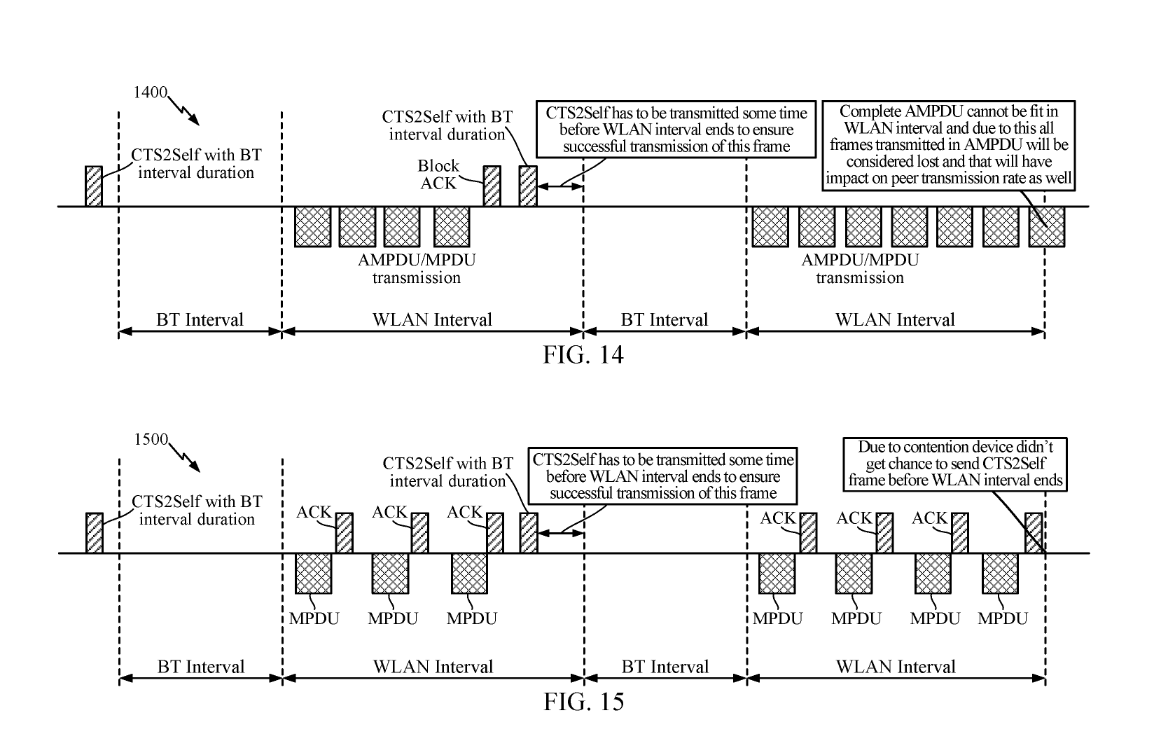

FIGS. 14 and 15 illustrate example exchanges of messages using a clear-to-send-to-self (CTS-to-self) based technique. As shown in FIG. 14, a CTS-to-self frame can be transmitted before the end of the WLAN interval. The CTS-to-self frame can indicate the BT interval duration and request (A-)MPDU(s) to be transmitted in the next WLAN interval. Then, in the next WLAN interval, the AP (or P2P device) can begin transmitting the (A-)MPDU(s). Then, the non-AP STA can send a BA frame for the transmitted (A-)MPDUs and send another CTS-to-self frame in the WLAN interval. However, as shown in FIG. 14, in some cases, a complete (A-)MPDU may not fit before the end of the WLAN interval and the frames transmitted in the (A-)MPDU may be lost.

As shown in FIG. 15, the non-AP STA can send an ACK frame after each MPDU. However, in some cases, after receiving an MPDU and sending an ACK frame, the CTS-to-self may not fit in the remaining WLAN interval (e.g., due to medium contention). If the non-AP STA is not able to transmit the CTS-to-self frame before the next BT interval starts, this may lead to unsuccessful transmission by the AP or P2P GO during the BT interval which, in turn, may result in the AP or P2P GO rate to drop.

In some cases, not all intended recipients (e.g., the AP or P2P GO) may see the CTS-to-self frame. Further, there is no ACK frame sent for a CTS-to-self frame, therefore, the CTS-to-self frame may be unreliable. Also, the intended peers may be power-collapsed or hidden. Also, unintended STAs can see the CTS-to-self frame. For example, any receiver on the channel may see the CTS-to-self frame, even STAs not in the basic service set (BSS), and these unintended recipients may be controlled by the CTS-to-self frame. There may also be a short maximum duration. For example, the CTS-to-self frame may cover only up to about 30 milliseconds before another CTS-to-self is sent. Also, transmissions at times other than during the WLAN interval may be sent.

Accordingly, techniques for efficient frame exchanges for coexisting wireless devices are desirable.

According to certain aspects, a new null frame exchange is provided herein that includes an indication of an available duration in reserved bits of the null frame.

According to certain aspects, reserved fields in the quality-of-service (QOS) control field of a null frame may be used to indicate the available duration. In the null frame QOS control field, bits 7-15 may be reserved. The non-AP STA may use these reserved bits to indicate the duration (e.g., in TU) that the non-AP STA will be available (e.g., the WLAN interval or null frame transmission time). Alternatively, the non-AP STA may use the lower 9-bits of timing synchronization function (TSF) timer in the reserved bits when the WLAN interval ends.

According to certain aspects, the non-AP STA and AP/P2P GO may negotiate the exchange of these null frames as part of an association procedure (e.g., ssociation request and association response message exchange), for example, using a vendor specific information element (IE).

According to certain aspects, the recipient of the null frame (e.g., the AP or P2P GO) may interpret the null frame according to conventional techniques if the null frame has PM set to 0. If the PM is set to 1 and the reserved bits 7-15 are set to zero, then the recipient will consider the non-AP STA as gone into the power save mode according to the conventional techniques. However, if the PM is set to 1 and the reserved bits 7-15 are set to non-zero values, then the AP may know that the non-AP STA is available for reception (e.g., out of power save mode) for the duration indicated by the values of the reserved bits 7-15.

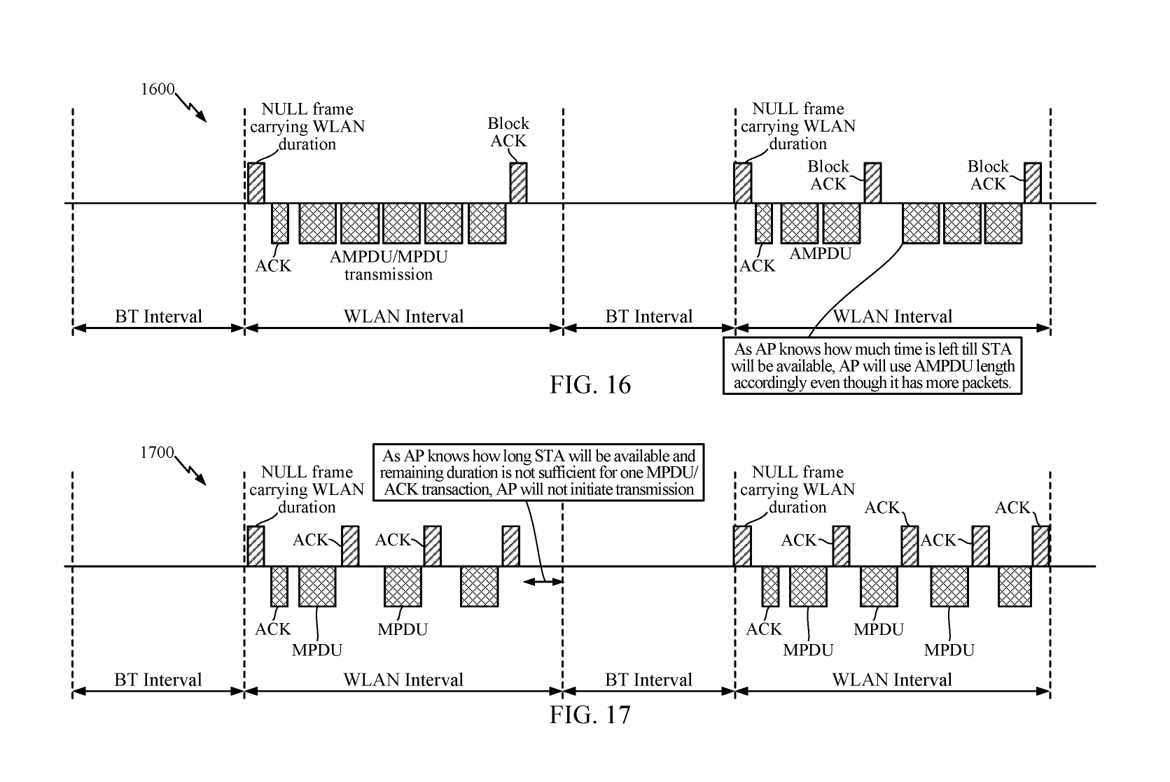

FIGS. 16 and 17 illustrate example exchanges of messages using a new null frame based technique, in accordance with certain aspects of the present disclosure. As shown in FIG. 16, the non-AP STA may send the null frame carrying the WLAN duration to the AP (or P2P GO) and the AP may respond with an ACK frame and the (A-)MPDU(s). The non-AP STA may send a BA frame for the (A-)MPDU(s) or may send multiple BA frames. According to certain aspects, since the AP may know how long the non-AP STA is available, the AP can use an appropriate length of (A-)MPDU(s), even if the AP may still have packets to send. Thus, the AP can avoid transmitting an (A-)MPDU that would not fit within the WLAN interval.

As shown in FIG. 17, the non-AP STA may send an ACK frame after each MPDU. Since the AP knows the available duration, the AP may avoid sending an MPDU if the AP knows that there is not enough time for the MPDU to be sent and for the non-AP STA to acknowledge the MPDU.

According to certain aspects, providing the available duration in the null frame may be fair to the other devices in the medium. This technique may also result in complete or near complete utilization of the entire WLAN interval, since the AP (or P2P GO) knows the duration and can schedule its data transmissions accordingly. This technique may have less overhead, as fewer number of frames may be transmitted over the air, for example, as compared to the PS-Poll and Null frame approaches illustrated in FIGS. 11-13. The AMPDU duration may be controlled dynamically based on available duration and, therefore, aggregation may be used even in coexistence mode. This technique may also avoid the AP or P2P GO attempting transmissions during the BT interval and may lead to a smaller number of retransmissions, avoid rate drop, and have a positive impact on throughput.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting may comprise a transmitter (e.g., the transmitter unit 222) and/or an antenna(s) 224 of the access point 110 illustrated in FIG. 2 or the transmitter 310 and/or antenna(s) 316 depicted in FIG. 3. Means for receiving may comprise a receiver (e.g., the receiver unit 222) and/or an antenna(s) 224 of the access point 110 illustrated in FIG. 2 or the receiver 312 and/or antenna(s) 316 depicted in FIG. 3. Means for processing, means for determining, means for detecting, means for scanning, means for selecting, means for generating, means for outputting, or means for terminating operation may comprise a processing system, which may include one or more processors, such as the RX data processor 242, the TX data processor 210, and/or the controller 230 of the access point 110 illustrated in FIG. 2 or the processor 304 and/or the DSP 320 portrayed in FIG. 3.

According to certain aspects, such means may be implemented by processing systems configured to perform the corresponding functions by implementing various algorithms (e.g., in hardware or by executing software instructions) described above for performing fast association. For example, means for generating a frame may be implemented by a processing system performing an algorithm that generates a frame with an indication of a type of device that is to use a particular enhanced distributed channel access (EDCA) parameter set, and means for outputting a frame for transmission may be implemented by a (same or different) processing system performing an algorithm that takes, as input, the generated frame and generates signals to enable/disable the radio functions accordingly.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term receiver may refer to an RF receiver (e.g., of an RF front end) or an interface (e.g., of a processor) for receiving structures processed by an RF front end (e.g., via a bus). Similarly, the term transmitter may refer to an RF transmitter of an RF front end or an interface (e.g., of a processor) for outputting structures to an RF front end for transmission (e.g., via a bus).

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications by a wireless device, comprising:
a memory; and
at least one processor coupled with the memory and configured to:
generate a polling frame to poll an access point for data, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and
transmit the polling frame to the access point.

2. The apparatus of claim 1, wherein:
the polling frame comprises a single polling frame; and
the at least one processor is further configured to:
receive the multiple PDUs during the service period in response to the single polling frame; and
transmit a block acknowledgement frame acknowledging the multiple PDUs received from the access point during the service period.

3. The apparatus of any of claim 1, wherein the at least one processor is configured to transmit the polling frame as a multi-user (MU) transmission with one or more other polling frames from one or more other wireless devices.

4. The apparatus of claim 1, wherein the polling frame comprises a management frame.

5. The apparatus of claim 4, wherein the management frame comprises a control frame having a control field carrying the indication of the service period.

6. The apparatus of claim 5, wherein the control field also carries an indication of one or more receive parameters to be used in at least one of the service period or a subsequent service period.

7. The apparatus of claim 6, wherein the one or more receive parameters comprise at least one of: a number of spatial streams, a number of channel bandwidth, or a modulation and coding scheme (MCS).

8. The apparatus of claim 6, wherein the control field also carries one or more bits indicating the one or more receive parameters are changed relative to a default or current set of receive parameters.

9. The apparatus of claim 1, wherein the polling frame also carries an indication of a starting time of a subsequent service period.

10. The apparatus of claim 1, wherein the polling frame comprises a null frame.

11. The apparatus of claim 10, wherein the at least one processor is configured to provide the indication of the service period by non-zero values of one or more reserved bits of the null frame.

12. The apparatus of claim 10, wherein the at least one processor is further configured to:
indicate, during an association procedure with the access point, a capability of the wireless device to send the null frame carrying the indication.

13. The apparatus of claim 10, wherein the at least one processor is configured to set a value of a field in the null frame to indicate that the wireless device is entering a power save mode.

14. The apparatus of claim 10, wherein the indicated service period comprises a wireless local area network (WLAN) interval.

15. An apparatus for wireless communications by an access point, comprising:
a memory; and
at least one processor coupled with the memory and configured to:
receive a polling frame from at least one wireless device, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and
transmit the multiple PDUs to the wireless device during the service period, in response to the polling frame.

16. The apparatus of claim 15, wherein the at least one processor is further configured to:
receive a block acknowledgement frame acknowledging the multiple PDUs transmitted from the access point during the service period.

17. The apparatus of claim 15, wherein the at least one processor is configured to receive the polling frame as a multi-user (MU) transmission with one or more other polling frames from one or more other wireless devices.

18. The apparatus of claim 15, wherein the at least one processor is configured to:
determine the wireless device has entered a low power state after the service period has ended.

19. The apparatus of claim 15, wherein the polling frame comprises a management frame.

20. The apparatus of claim 19, wherein the management frame comprises a control frame having a control field carrying the indication of the service period.

21. The apparatus of claim 20, wherein the control field also carries an indication of one or more receive parameters to be used in at least one of: the service period or a subsequent service period.

22. The apparatus of claim 21, wherein the one or more receive parameters comprise at least one of: a number of spatial streams, a number of channel bandwidth, or a modulation and coding scheme (MCS).

23. The apparatus of claim 20, wherein the control field also carries one or more bits indicating the one or more receive parameters are changed relative to a default or current set of receive parameters.

24. The apparatus of claim 15, wherein the polling frame also carries an indication of a starting time of a subsequent service period.

25. The apparatus of claim 15, wherein the received polling frame comprises a null frame.

26. The apparatus of claim 25, further comprising:
indicating a capability of the wireless device to receive the null frame carrying the indication during an association procedure with the access point.

27. The apparatus of claim 25, wherein a value of a field in the null frame is set to indicate that the wireless device is entering a power save mode.

28. The apparatus of claim 25, wherein the indicated service period comprises a wireless local area network (WLAN) interval.

29. A method for wireless communications by a wireless device, comprising:
generating a polling frame to poll an access point for data, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and
transmitting the polling frame to the access point.

30. A method for wireless communications by an access point, comprising:
receiving a polling frame from at least one wireless device, the polling frame including an indication of a service period during which the access point may deliver multiple protocol data units (PDUs) to the wireless device in response to the polling frame, wherein the indication of the service period is provided as a value relative to a local clock synchronized between the wireless device and the access point; and
transmitting the multiple PDUs to the wireless device during the service period, in response to the polling frame.
